(19) United States
(12) Patent Application Publication
(10) Pub. No.: US 2018/0131642 A1
(43) Pub. Date: May 10, 2018

(54) CONVERSATION RUNTIME

(71) Applicant: Microsoft Technology Licensing, LLC, Redmond, WA (US)

(72) Inventors: Adina Magdalena TRUFINESCU, Redmond, WA (US); Vishwac Sena KANNAN, Redmond, WA (US); Khuram SHAHID, Seattle, WA (US); Aleksandar UZELAC, Seattle, WA (US); Joanna MASON, Redmond, WA (US); David Mark EICHORN, Redmond, WA (US); Rob CHAMBERS, Sammamish, WA (US)

(73) Assignee: Microsoft Technology Licensing, LLC, Redmond, WA (US)

(21) Appl. No.: 15/627,252

(22) Filed: Jun. 19, 2017

Related U.S. Application Data
(60) Provisional application No. 62/418,089, filed on Nov. 4, 2016.

(51) Int. Cl. H04L 12/58; G10L 15/26; G10L 15/30; G10L 13/08; G10L 15/22

(52) U.S. Cl. CPC H04L 51/02; G10L 15/265; G10L 2015/223; G10L 13/08; G10L 15/22; G10L 15/30

(57) ABSTRACT

Examples are disclosed that relate to a conversation runtime for automating transitions of conversational user interfaces. One example provides a computing system comprising a logic subsystem and a data-holding subsystem. The data-holding subsystem comprises instructions executable by the logic subsystem to execute a conversation runtime configured to receive one or more agent definitions for a conversation robot program, each agent definition defining a state machine including a plurality of states, detect a conversation trigger condition, select an agent definition for a conversation based on the conversation trigger condition, and execute a conversation dialog with a client computing system using the agent definition selected for the conversation and automatically transition the state machine between different states of the plurality of states during execution of the conversation dialog.

### CROSS REFERENCE TO RELATED APPLICATIONS

This application claims priority to U.S. Provisional Patent Application No. 62/418,089, filed Nov. 4, 2016, the entirety of which is hereby incorporated herein by reference.

### BACKGROUND

Conversation-based user interfaces may be used to perform a wide variety of tasks. For example, a conversation robot or “bot” program, executed on a computing system, may utilize conversation-based dialogs to book a reservation at a restaurant, order food, set a calendar reminder, order movie tickets, and/or perform other tasks. Such conversations may be modeled as a flow including one or more statements/question and answer cycles. Some such flows may be directed, structured flows that include branches to different statements/questions based on different user input.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to a conversation runtime for automating transitions of conversational user interfaces. One example provides a computing system comprising a logic subsystem and a data-holding subsystem. The data-holding subsystem comprises instructions executable by the logic subsystem to execute a conversation runtime configured to receive one or more agent definitions for a conversation robot program, each agent definition defining a state machine including a plurality of states, detect a conversation trigger condition, select an agent definition for a conversation based on the conversation trigger condition, and execute a conversation dialog with a client computing system using the agent definition selected for the conversation and automatically transition the state machine between different states of the plurality of states during execution of the conversation dialog.

### BRIEF DESCRIPTION OF THE DRAWINGS

FIG. 1 shows an example conversation runtime environment.

FIGS. 2-3 show an example flow of a modeled conversation including states and transitions.

FIG. 4 shows an example method for executing a conversation dialog with a client computing system using a conversation runtime.

FIG. 5 shows a sequence diagram that illustrates an example sequence of calls when a client computing system provides text-based user input to communicate with a conversation bot program executed by a conversation runtime.

FIG. 6 shows a sequence diagram that illustrates an example sequence of calls when a client computing system provides speech-based user input to communicate with a conversation bot program executed by a conversation runtime.

FIG. 7 shows an example computing system.

### DETAILED DESCRIPTION

As discussed above, a conversation may be modeled as a flow. The flow of the conversation as well as logic configured to perform one or more actions resulting from the conversation may be defined by an agent definition that is created by a developer. For example, such logic may define state transitions between questions and responses in the conversation, as well as other actions that result from the conversation.

Each time a different robot or “bot” program is built by a developer, the developer is required to write execution code that is configured to interpret the agent definition in order to execute the conversation according to the modeled flow. Further, the developer is required to implement logic to perform the actions resulting from the conversation. Repeatedly having to rewrite execution code for each bot program may be labor intensive for developers, error prone due to iterative changes during development, and may increase development costs of the bot programs.

Accordingly, examples are disclosed herein that relate to a conversation runtime that consolidates the functionality required for a developer to implement a bot program that executes a conversation dialog according to a modeled flow as defined by an agent definition. In some examples, the conversation runtime may be implemented as a portable library configured to interpret and execute state transitions of a conversation state machine defined by the agent definition. By implementing the conversation runtime, bot-specific execution code does not have to be rewritten by a developer each time a different instance of a bot program is created. Accordingly, the amount of time required for the developer to develop a conversation dialog and iteratively make changes to the conversation dialog going forward may be reduced. Moreover, the conversation runtime may consolidate the functionality of different portions of developer-specific execution code in a streamlined fashion that reduces a memory footprint to execute the conversation dialog.

Furthermore, the conversation runtime automates various functionality that would otherwise be required to be programed by a developer. For example, the conversation runtime may be configured to integrate with speech-recognition and language-understanding components to resolve both user speech-to-text and then text-to-intent/entities. In another example, the conversation runtime may be configured to allow for selecting and binding to predefined user-interface cards on response/prompt states. In another example, the conversation runtime may be configured to plug into available text-to-speech (TTS) engines (per system/platform) to synthesize response text or speech. The conversation runtime may be configured to automatically choose between one or more input and output modalities such as speech-to-text and text-to-speech vs. plain text vs. plain text with abbreviated messages, etc., based on the capabilities of the device or system on which the client is being executed, or an indication from the client.

The conversation runtime further may be configured to enable language-understanding with the ability to choose between default rules of a language-understanding-intelligent system or developer-provided language-understanding modules. In still another example, the conversation runtime may be configured to enable context carry-over across different conversations, and to allow for conversation flow to be modularized. Further, the conversation runtime may be configured to allow for the creation of global commands understandable by different bot programs and in different conversations. The conversation runtime may support flow control constructs (e.g., go back, cancel, help) that help navigate the conversation state machine in a smooth manner that may improve the runtime experience of a computing device. Such global flow control constructs also may help decrease the required amount of time to develop the conversation dialog by providing unified common implementations across all states. Further, such global flow control constructs may provide a more consistent user experience across an entire set of different conversations/experiences authored for execution using the conversation runtime.

Such automated functionality provided by the conversation runtime may improve a user interface of an executed conversation dialog by being able to understand and disambiguate different forms of user input in order to provide more accurate responses during a conversation. In this way, the conversation runtime may improve the speed at which the user can interact with the user interface to have a conversation. Moreover, the improved speed and accuracy may result in an increase in usability of the user interface of the conversation dialog that may improve the runtime experience of the computing device.

Additionally, the conversation runtime may be configured to allow a developer to control the flow by running customized code at different turns in the conversation at runtime. For example, the conversation runtime may allow a developer to execute customized business logic in place of default policies (e.g., values) during execution of a conversation. In some examples, the conversation runtime may allow the customized business logic to access the conversation dialog to dynamically deviate from a default state of the modeled flow. Such a feature enables a bot program to have a default level of functionality without intervention from the developer, while also allowing the developer to customize the conversation flow as desired. Furthermore, the conversation runtime may be configured to enable execution of conversations on multiple different clients (e.g., applications, personal automated assistant, web client) and handle different input forms (e.g., speech, text).

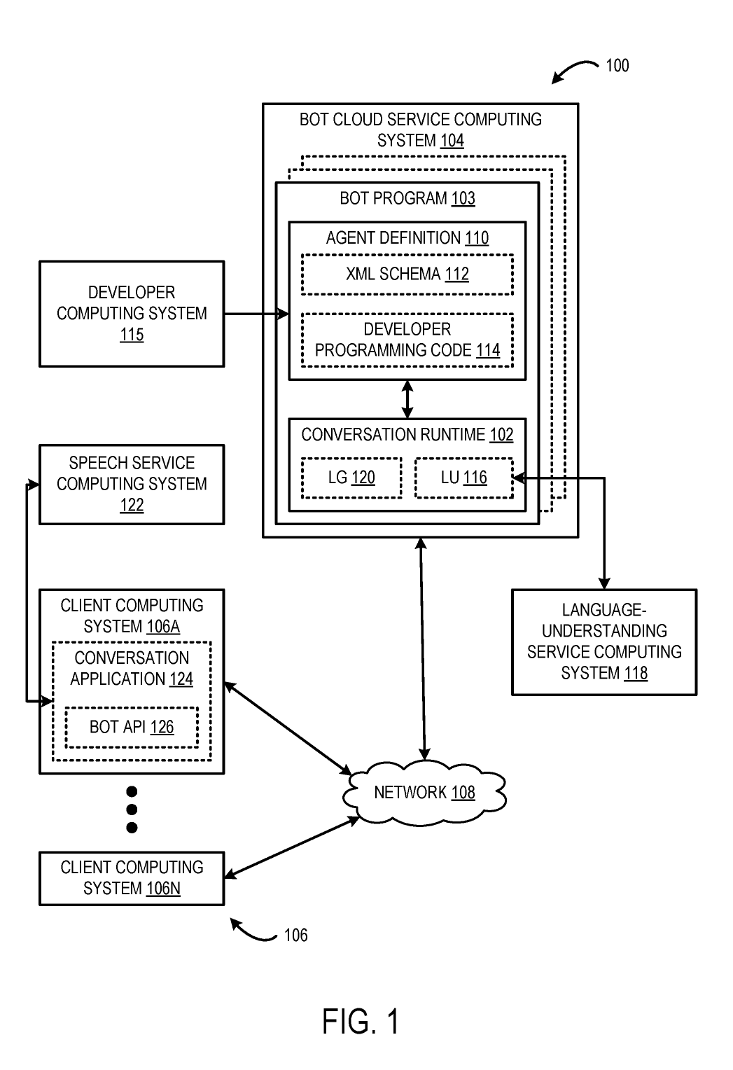

FIG. 1 shows an example conversation runtime environment 100 in which a conversation runtime 102 may be implemented. The conversation runtime 102 may be executed by a bot cloud service computing system 104 in communication with a plurality of client computing systems 106 (e.g., 106A-106N), via a network 108, such as the Internet. The conversation runtime 102 may be instantiated as a component of each of one or more bot programs 103 configured to conduct a conversation dialog according to a flow with one or more of the plurality of client systems 106. In some examples, the conversation runtime 102 may be implemented as a portable library configured to interpret and execute one or more agent definitions 110. For example, the conversation runtime 102 may be configured to receive, for each bot program 103, one or more agent definitions 110. Each agent definition 110 defines a different modeled conversation. A modeled conversation may include one or more of a flow (e.g., a directed, structured flow), a state machine, or another form of model, for example. As such, the term “agent” may represent any suitable data/command structure which may be used to implement, via a runtime environment, a conversation flow associated with a system functionality. The one or more agent definitions 110 received by the conversation runtime 102 may be received from and/or created by one or more developers, such as a developer computing system 115.

In one example implementation, the agent definition 110 includes an XML schema 112 (or schema of other suitable format) and developer programming code (also referred to as code behind) 114. For example, the XML schema 112 may designate a domain (e.g., email, message, alarm, appointment, reservation), one or more intents (e.g., “set an alarm” intent may be used for an alarm domain), one or more slots associated with an intent (e.g., slots of a “make a reservation” intent may include a date, time, duration, and location), one or more states of the conversation flow, one or more state transitions, one or more phrase lists, one or more response strings, one or more language-generation templates to generate prompts, and one or more user interface templates.

The developer programming code 114 may be configured to implement and manage performance of one or more requested functions derived from the XML, schema 112 during execution of a conversation by the conversation runtime 102. Further, the developer programming code 114 may be configured to control, via the conversation runtime 102, a conversation flow programmatically by setting the value of slots, execution of conditional blocks and process blocks, and transition the conversation state machine to a particular state for the purpose of cancelling or restarting the conversation.

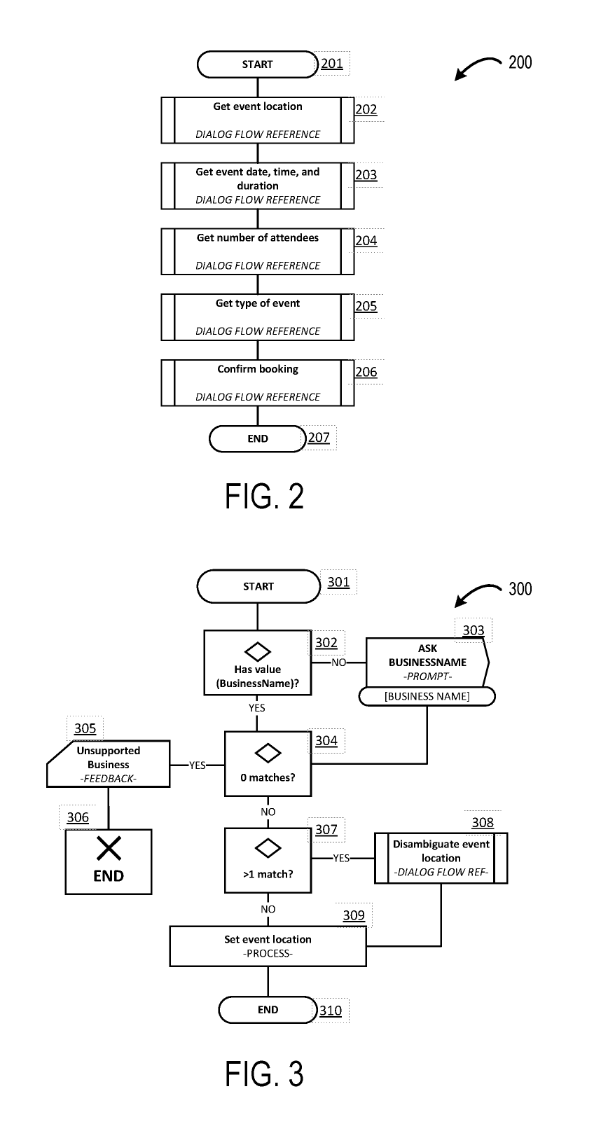

FIGS. 2-3 show an example flow 200 of a modeled conversation dialog including states and transitions that may be defined by an agent definition, such as the agent definition 110 of FIG. 1. In FIG. 2, the flow 200 includes a plurality of dialog reference blocks from a start block 201 to an end block 207. Each reference block may correspond to a different state of the flow 200. In operation, the flow 200 returns a series of values (slots) from one or more sub-dialog flows once the flow 200 is completed. In this example, the flow 200 is configured to book a reservation for an event. At reference block 202, an event location may be determined. At reference block 203, an event date, time, and duration may be determined. At reference block 204, a number of attendees of the event may be determined. At reference block 205, an event type may be determined. At reference block 206, a confirmation to book the reservation may be received, and then the flow 200 ends at reference block 207.

FIG. 3 shows a sub-dialog flow 300 associated with the reference block 202 of the flow 200. In this example, the sub-dialog flow 300 is configured to determine a location of the event for which the reservation is being made. The sub-dialog flow 300 includes a plurality of dialog flow reference blocks from a start state 301 to an end state 310 and an end failure state 306. At reference block 302, the flow looks for a value representing a business name to be provided by the user. If no value is provided, the flow 300 transitions to reference block 303. Otherwise, the flow 300 transitions to reference block 304. At reference block 303, the user is prompted to provide a business name, and the flow transitions to reference block 304. At reference 304, it is determined whether the provided business name matches any known business names. If the provided business name does not match any known business names (or if no business name is provided by the user at reference block 303), then the flow 300 transitions to 305. Otherwise, if the provided business name matches at least one known business name, then the flow transitions to reference block 307. At reference block 305, a message indicating that the provided business is unsupported is presented to the user, and the flow 300 transitions to reference block 306. The end failure state 306 in this dialog flow represents a state in which the human user participating in the dialog fails to utter a name of a business supported in this dialog flow. In the case that the human user fails to utter the name of a business supported in this dialog flow, the Get event location dialog flow reference 202 of FIG. 2 may start over again, the user may start the main dialog flow 200 over again, the main dialog flow 200 may be canceled, or any other suitable action may be taken.

Continuing with sub-dialog flow 300, at reference block 307, it may be determined whether the provided business name matches more than one known business name. If the provided business name matches more than one known business name, then the flow 300 transitions to reference block 308. Otherwise, if the provided business name matches exactly one known business name, then the flow transitions to reference block 309. At reference block 308, the event location is disambiguated between the multiple known business names, and the flow 300 transitions to reference block 309. At reference block 309, the event location is set to the business name, the sub-dialog flow 300 returns to the main flow 200, and the flow 200 transitions to reference block 203. The above described dialog flow is provided as an example and is meant to be non-limiting.

Continuing with FIG. 1, the conversation runtime 102 may be configured to execute a conversation dialog with any suitable client, such as the client computing system 106A. Non-limiting examples of a client computing system include a mobile computing device, such as a smartphone, or a tablet, a holographic device, a display device, a game console, a desktop computer, and a server computer. In some cases, a client may include a user controlled computing system. In some cases, a client may include another bot program executed by a computing system.

The client computing system 106A may include a conversation application 124 configured to interact with the bot program 103. The conversation application 124 may be configured to present a conversation user interface that graphically represents a conversation dialog. The client computing system 106A may include any suitable number of different conversation applications configured to interact with any suitable number of different bots via any suitable user interface. Non-limiting examples of different conversation applications include movie applications, dinner reservation, travel applications, calendar applications, alarm applications, personal assistant applications, and other applications.

The conversation runtime 102 may be configured to execute a conversation dialog with a client based on detecting a conversation trigger condition. In one example, the conversation trigger condition includes receiving user input from the client computing system that triggers execution of the conversation (e.g., the user asks a question, or requests to start a conversation). In another example, the conversation trigger condition includes receiving a sensor signal that triggers execution of the conversation (e.g., the client is proximate to a location that triggers execution of a conversation).

Once execution of a conversation dialog is triggered, the conversation runtime 102 is configured to select an appropriate agent definition from the one or more agent definitions 110 based on the trigger condition. For example, if the trigger condition includes the user asking to “watch a movie”, then the conversation runtime 102 may select an agent definition that defines a flow for a conversation dialog that facilitates a user to select a movie to watch. In some examples, the conversation runtime 102 may be configured to select a specific flow from multiple different flows within the selected agented definition, and execute the selected flow based upon the specific trigger condition. Returning to the above-described example, if the user provides a triggering phrase that includes additional information, such as, “watch a movie starring Actor A,” a specific flow may be identified and executed to provide an appropriate response having information relating to the additional information provided in the triggering phrase. An agent definition may define any suitable number of different flows and associated trigger conditions that result in different flows being selected and executed. In some examples, the conversation runtime 102 is configured to execute the conversation dialog according to a directed flow by executing a state machine defined by the agent definition 110. Further, during execution of the conversation dialog, the conversation runtime 102 may be configured to follow rules, execute business logic to perform actions, ask questions, provide response, determine the timing of ask/response, present user interfaces according to the selected agent definition 110 until the agent definition 110 indicates that the conversation is over.

The conversation runtime 102 may be configured to employ various components to facilitate execution of a conversation dialog. For example, the conversation runtime 102 may be configured to employ language understanding (LG), language generation (LG), dialog (a model of the conversation between the user and the runtime), user interface (selecting and binding predefined UI cards on response/prompt states), speech recognition (SR), and text to speech (TTS) components to execute a conversation. When user input is received via the client computing system 106A, the conversation application 124 may determine the type of user input. If the user input is text-based user input, then the client program 124 may send the text to the bot program 103 to be analyzed by the conversation runtime 102. If the user input is speech-based, then the client program 124 may send the audio data corresponding to the speech-based input to a speech service computing system 122 configured to translate the audio data into text. The speech service computing system 122 may send the translated text back to the client computing system 106A, and the client computing system 106A may send the text to the bot program 103 to be analyzed by the conversation runtime 102.

In some implementations, the client computing system 106A may send the speech-based audio data to the bot program 103, and the conversation runtime 102 may send the audio data to the speech service computing system 122 to be translated into text. Further, the speech service computing system 122 may send the text to the bot cloud service computing system 104 to be analyzed by the conversation runtime 102.

In some implementations, the conversation runtime 102 may include a language-understanding component 116 to handle translation of received user input into intents, actions, and entities (e.g., values). In some examples, the language-understanding component 116 may be configured to send received user input to a language-understanding service computing system 118. The language-understanding service computing system 118 may be configured to translate the received user input into intents, actions, and entities (e.g., values). The language-understanding service computing system 118 may be configured to return the translated intents, actions, and entities to the language-understanding component 116, and the conversation runtime 102 may use the intents, actions, and entities (e.g., values) to direct the conversation—i.e., transition to a particular state in the state machine.

The language-understanding service computing system 118 may be configured to translate any suitable type of user input into intents, actions, and entities (e.g., values). For example, the language-understanding service computing system 118 may be configured to translate received text into one or more values. In another example, the language-understanding service computing system 118 may be configured to translate audio data corresponding to speech into text that may be translated into one or more values. In another example, the language-understanding service computing system 118 may be configured to receive video data of a user and determine the user's emotional state or identify other nonverbal cues (e.g., sign language), translate such information into text, and determine one or more values from the text.

In some examples, the language-understanding component 116 may be configured to influence speech recognition operation performed by the language-understanding service computing system 118 based on the context or state of the conversation being executed. For example, during execution of a conversation dialog, a bot program may ask a question and present five possible values as responses to the question. Because the conversation runtime 102 knows the state of the conversation, the conversation runtime 102 can provide the five potential answers to the speech service computing system 122 via the conversation application 124 executed by the client computing system 106A. The speech service computing system 122 can bias operation toward listening for the five potential answers in speech-based user input provided by the user. In this way, the likelihood of correctly recognizing user input may be increased. The ability of the conversation runtime 102 to share the relevant portion (e.g., values) of the conversation dialog with the speech service computing system 112 may improve overall speech accuracy and may make the resulting conversation more natural.

When the conversation runtime 102 transitions the state machine to a response-type state, the conversation runtime 102 may be configured to generate a response that is sent to the client computing system 106A for presentation via the conversation application 124. In some examples, the response is a visual response. For example, the visual response may include one or more of text, an image, a video (e.g., an animation, a three-dimensional (3D) model), other graphical elements, and/or a combination thereof. In some examples, the response is a speech-based audio response. In some examples, a response may include both visual and audio portions.

In some implementations, the conversation runtime 102 may include a language-generation component 120 configured to resolve speech and/or visual (e.g., text, video) response strings for each turn of the conversation provided by the conversation runtime 102 to the client computing system 106A. Language-generation component 120 may be configured to generate grammatically-correct and context-sensitive language from the language-generation templates defined in the XML schema of agent definition 110. Such language-generation templates may be authored to correctly resolve multiple languages/cultures taking in to account masculine/feminine/neuter modifiers, pluralization, honorifics, etc. such that sentences generated by language-generation component 120 are grammatically correct and colloquially appropriate.

For the example case of handling speech generation, the language-generation component 120 may be configured to send response text strings to the client computing system 106A, and the client computing system 106A may send the response text strings to a speech service computing system 122. The speech service computing system 122 may be configured to translate the response text strings to audio data in the form of synthesized speech. The speech service computing system 112 may be configured to send the audio data to the client computing system 106A. The client computing system 106A may present the synthesized speech to the user at the appropriate point of the conversation. Likewise, when user input is provided in the form of speech at the client computing system 106A, the client computing system 106A may send the audio data correspond to the speech to the speech service computing system 122 to translate the speech to text, and the text may be provided to the conversation runtime 102 via the language-generation component 120.

In another example, the language-generation component 120 may be configured to determine a response text string, and translate the text to one or more corresponding images or a video that may be sent to the client computing system 106A for presentation as a visual response. For example, the language-generation component 120 may be configured to translate text to a video of a person performing sign language that is equivalent to the text.

In some implementations, the conversation runtime 102 may be configured to communicate directly with the speech service computing system 122 to translate text to speech or speech to text instead of sending text and/or audio data to the speech service computing system 122 via the client computing system 106A.

In some implementations, the conversation runtime 102 may be configured to allow the developer to customize the directed flow of a modeled conversation by deviating from default policies/values defined by the XML schema 112 and instead follow alternative policies/values defined by the developer programming code 114. Further, during operation, the conversation runtime 102 may be configured to select and/or transition between different alternative definitions of the developer programming code 114 in an automated fashion without developer intervention.

In some implementations, the conversation runtime 102 may be configured to execute a plurality of different conversations with the same or different client computing systems. For example, the conversation runtime 102 may execute a first conversation with a user of a client computing system to book a reservation for a flight on an airline using a first agent definition. Subsequently, the conversation runtime 102 may automatically transition to executing a second conversation with the user to book a reservation for a hotel at the destination of the flight using a different agent definition.

In some implementations, the conversation runtime 102 may be configured to arbitrate multiple conversations at the same time (for the same and/or different clients). For example, the conversation runtime 102 may be configured to store a state of each conversation for each user in order to execute multiple conversations with multiple users. Additionally, in some implementations, the conversation runtime 102 may be configured to deliver different conversation payloads based on a type of client (e.g., mobile computing device vs desktop computer) or a mode in which the client is currently set (e.g., text vs speech) with which a conversation is being executed. For example, the conversation runtime 102 may provide a speech response when speech is enabled on client computing system and provide a text response when speech is disabled on a client computing system. In another example, the conversation runtime 102 may provide text, high-quality graphics, and animations in response to a rich desktop client while providing text only in response to a slim mobile client.

In some implementations, the conversation runtime 102 may be configured to implement a bot program in different frameworks. Such functionality may allow the agent definitions (e.g., conversations and code) authored by a developer for a conversation runtime to be ported to different frameworks without the agent definition having to be redone for each framework.

Further, in some such implementations, the conversation application 124 may include a bot API 126 configured to enable a developer to build a custom conversation user interface that can be tightly integrated with a user interface of the conversation application 124. The bot API 126 may allow the user to enter input as either text or speech in some examples. When the input is text, the bot API 126 allows the conversation application 126 to listen for the user's speech at each prompt state, convert the speech to text, and send the text phrase to the conversation runtime 102 with an indication that the text was generated via speech. The conversion runtime 102 may advance the conversation based on receiving the text. As the conversation runtime 102 advances the state machine, the conversation runtime 102 may communicate the transitions to the bot API 126 on the client computing system 106A. At each transition, the bot API 126 can query the conversation runtime 102 to determine values of slots and a current state of the conversation. Further, the bot API 126 may allow the conversation application 124 to query the conversation runtime 102 for the current state of the conversation and slot values. The bot API 126 may allow the conversation application 124 to programmatically pause/resume and/or end/restart the conversation with the conversation runtime 102.

The conversation runtime 102 may be configured to automate a variety of different operations/functions/transitions that may occur during execution of a modeled conversation. For example, the conversation runtime 102 may be configured to execute a conversation by invoking a selected agent definition 110 to evaluate a condition that will determine a branching decision or execute code associated with a processing block.

The conversation runtime 102 may be configured to manage access by the agent definition 110 to various data/states of the flow during execution of the modeled conversation in an automated manner. For example, the conversation runtime 102 may be configured to provide the agent definition 110 with access to slot values provided by a client or otherwise determined during execution of the modeled conversation. In another example, the conversation runtime 102 may be configured to notify the agent definition 110 of state transitions. In another example, the conversation runtime 102 may be configured to notify the agent definition 110 when the conversation is ended.

The conversation runtime 102 may be configured to allow the agent definition 110 to edit/change aspects of the flow during execution of the modeled conversation in an automated manner. For example, the conversation runtime 102 may be configured allow the agent definition 110 to change values of slots, add slots, change a response text by executing dynamic template resolution and language generation, and change a TTS response (e.g., by generating audio with custom voice which the conversation runtime passes as SSML to the bot API to render). In another example, the conversation runtime 102 may be configured to allow the agent definition 110 to dynamically provide a prompt for the client to provide disambiguation grammar that the conversation runtime 102 can receive. In another example, the conversation runtime 102 may be configured to allow the agent definition 110 to provide a representation of the flow to be passed to the conversation application 124 for the purpose of updating and synchronizing the conversation application 124. In another example, the conversation runtime 102 may be configured to allow the agent definition 110 to restart the conversation from the beginning or end the conversation. In another example, the conversation runtime 102 may be configured to allow the agent definition 110 to programmatically inject XML code/modules at runtime and/or programmatically inject additional states and transitions at runtime.

The conversation runtime 102 is configured to advance a state machine during execution of a modeled conversation in an automated manner. The state machine may have different types of states, such as initial, prompt, response, process, decision, and return state types. For example, in FIG. 3, state 301 is an initial state, state 302 is a decision state, state 303 is a prompt state, state 305 is a response state, state 309 is a process state, and state 310 is a return state. As the conversation runtime 102 advances the state machine, the conversation runtime 102 may allow the agent definition 110 to access the conversation dialog to identify slot values and the current state. In some examples, the agent definition 110 can query the conversation dialog via the bot API 126 to receive the slot values and current state.

At each prompt state of the state machine, the conversation runtime 102 may interact with the language-understanding service computing system 118 via the language-understanding component 116. If the request to the language-understanding service computing system 118 fails, the conversation runtime 102 may retry to send the text string. While waiting for the language-understanding-service computing system 118 to respond, the conversation runtime 102 can switch to a response-type state in which a response is presented by the conversation application 124. For example, the response state may include presenting a text string stating, “Things are taking longer than expected.”

At each response state of the state machine, the conversation runtime 102 may be configured to interact with the language-generation component 120 to generate a response to be presented to the client. For example, the conversation runtime 102 may embed text received from the language generation component 120 in a graphical user interface (GUI) that is passed to the client computing system. In another example, the conversation runtime 102 may present audio data corresponding to text to speech (TTS) translation received from the language-generation component 120.

In some implementations, the conversation runtime 102 may be configured to coordinate the state machine transitions with the user interface transitions to allow the conversation application 124 to render the response before the conversation runtime 102 advances the state machine. Further, in some implementations, the conversation runtime 102 may include retry logic with custom strings for confirmation and disambiguation prompts and custom prompts. Additionally, in some implementations, the conversation runtime 102 may include support for inline conditional scripting, support for forward slot filling and slot corrections, and support for conversation modules, and may allow passing slot values into a module and return slot values from a module.

In some implementations, the conversation runtime 102 be configured to support conversation nesting where multiple conversation flows are executed in addition to the main conversation flow. In such implementations, the user can enter a nested conversation at any turn in the main conversation and then return to same point in the main conversation. For example: User: “I want movie tickets for Movie A.” bot: “Movie A is playing at Movie Theater B on Wednesday night.” User: “How's the weather on Wednesday?” [nested conversation]. bot: “It's sunny with zero chance of rain”. User: “great, buy me two tickets” [main conversation].

It will be appreciated that any suitable number of different bot programs 103 may be implemented in the bot cloud service computing system 104. Moreover, in some implementations, a bot program may be executed locally on a client computing system without interaction with the bot cloud service computing system 104.

The conversation runtime 102 may be configured to execute a conversation modeled using an agent definition 110 in a platform agnostic manner without dependencies on the operating system on which the conversation runtime 102 is being executed.

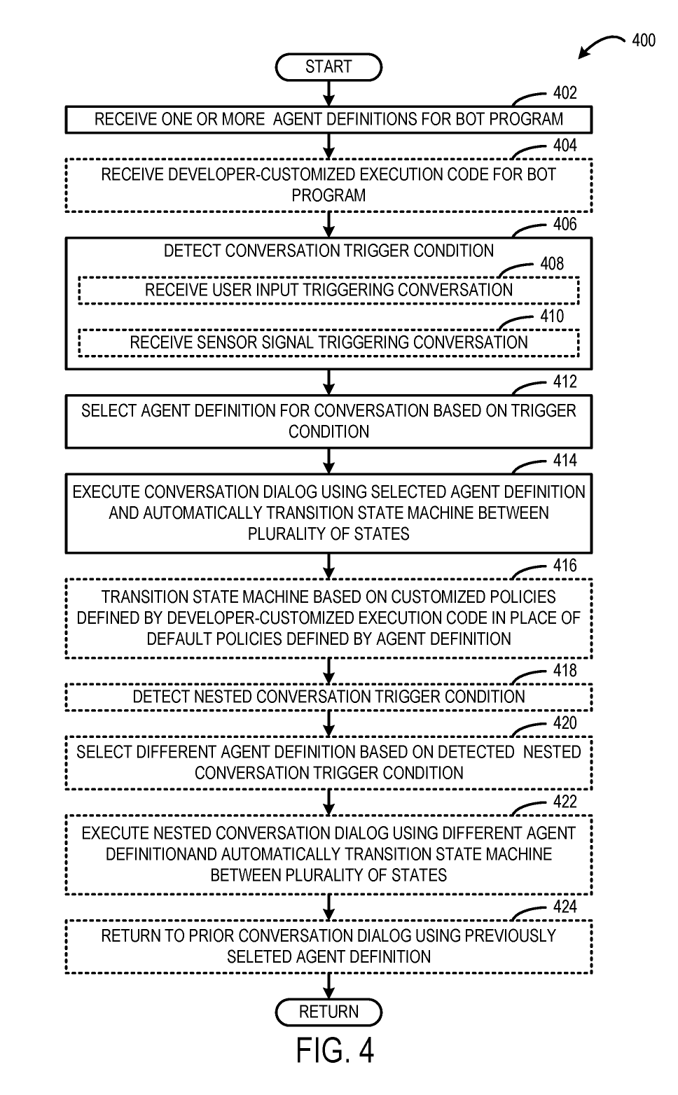

FIG. 4 shows an example method 400 for executing a conversation with a client using a conversation runtime. The method 400 may be performed by any suitable computing system. For example, the method 400 may be performed by the conversation runtime 102 of the bot cloud service computing system 104 of FIG. 1. At 402, the method 400 includes receiving one or more agent definitions for a bot program. Each agent definition defines a flow of a different modeled conversation. Further, the agent definition defines a state machine including a plurality of states. Any suitable number of agent definitions modeling different conversations may be received by the conversation runtime.

In some implementations, at 404, the method 400 optionally may include receiving developer-customized execution code for the bot program. The developer-customized execution code may define policies and/or values the deviate from default policies and/or values of the agent definition. For example, the developer-customized execution code may provide additional functionality (e.g., additional states) to the conversation dialog. In another example, the developer-customized execution code may change functionality (e.g., different slot values) of the conversation dialog.

At 406, the method 400 includes detecting a conversation trigger condition that initiates execution of a conversation with a client computing system.

In some implementations, at 408, the method 400 optionally may include receiving user input that triggers execution of a conversation. For example, a user may provide user input to a client in the form of a questions via text or speech that triggers a conversation. In some implementations, at 410, the method 400 optionally may include receiving a sensor signal that triggers execution of a conversation. For example, a location of the client computing system derived from a position sensor signal may indicate that a user is proximate to a location of interest, and the conversation runtime initiates a conversation associated with the location of interest.

At 412, the method 400 includes selecting an agent definition for the conversation based on the trigger condition. In some cases where the computing system receives a plurality of agent definitions for different modeled conversations, the conversation runtime may select an appropriate agent definition from the plurality of agent definitions based on the trigger condition. At 414, the method 400 includes executing a conversation dialog with the client computing system using the selected agent definition and automatically transitioning the state machine between the plurality of states during execution of the conversation dialog according to the agent definition. The conversation dialog may include as little as a single question or other text string posed by the conversation runtime. On the other hand, the conversation may be a series of back and forth interactions between the conversation runtime and the client as directed by the flow defined by the agent definition.

In some implementations where developer-customized execution code is received for the bot program, at 416, the method 400 optionally may include transitioning the state machine based on customized policies defined by the developer-customized execution code in place of default policies defined by the agent definition.

In some implementations, at 418, the method 400 optionally may include detecting a nested conversation trigger condition that initiates a different modeled conversation. In some examples, the nested conversation trigger condition may include receiving user input via text or speech that triggers a different conversation. For example, during a conversation to book a reservation for a flight to a destination, a user may provide user input inquiring about the current weather conditions at the destination. This switch in topics from flights to the weather may trigger initiation of a nested conversation that invokes a different bot program having a different agent definition. In another example, a sensor signal may trigger execution of a nested conversation.

In some implementations, at 420, the method 400 optionally may include selecting a different agent definition based on the detected nested conversation trigger condition. In some implementations, at 422, the method 400 optionally may include executing a nested conversation dialog using the different agent definition and automatically transition the state machine between the plurality of states during execution of the nested conversation dialog according to the different agent definition. In some implementations, at 424, the method 400 optionally may include returning to the prior conversation upon conclusion of the nested conversation, and continuing execution of the prior conversation based on the previously selected agent definition. For example, the conversation runtime 102 may store the state of the main conversation when the nested conversation begins, and may return to the same state when the nested conversation continues. Upon conclusion of the main conversation the method 400 may return to other operations.

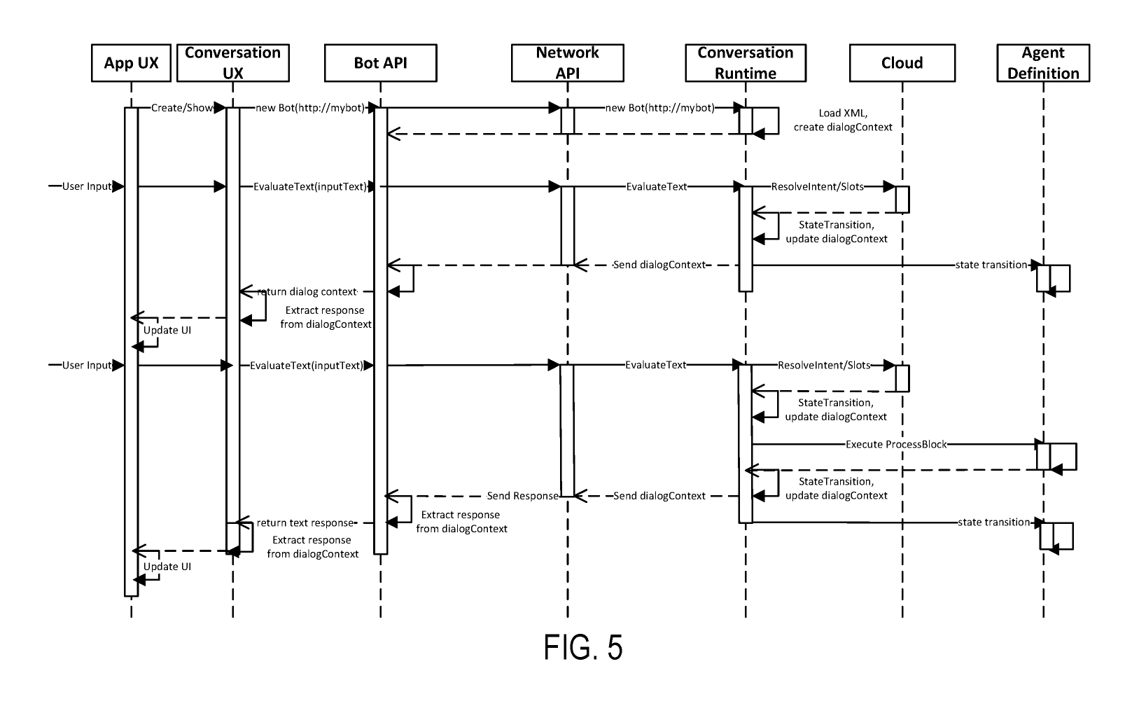

FIG. 5 shows a sequence diagram that illustrates a sequence of calls when a client computing system provides text-based user input to communicate with a conversation robot program executed by a conversation runtime. When a conversation trigger condition is detected at the client computing system, the conversation runtime executes a conversation dialog by selecting an appropriate agent definition and loading the associated XML files that define the state machine for the conversation dialog. When text-based user input is received at the client computing system via the conversation application, the client computing system sends the text to the cloud computing system to be evaluated by the conversation runtime based on the policies of the agent definition. The conversation runtime transitions between states of the state machine based on the received text to update the conversation dialog. The conversation robot program may send an appropriate text-based response based on the updated state of the conversation dialog to client computing system to be presented to the user via a user interface of the conversation application. This sequence (and/or other similar sequences) may be carried out each time text-based user input is received during execution of the conversation dialog.

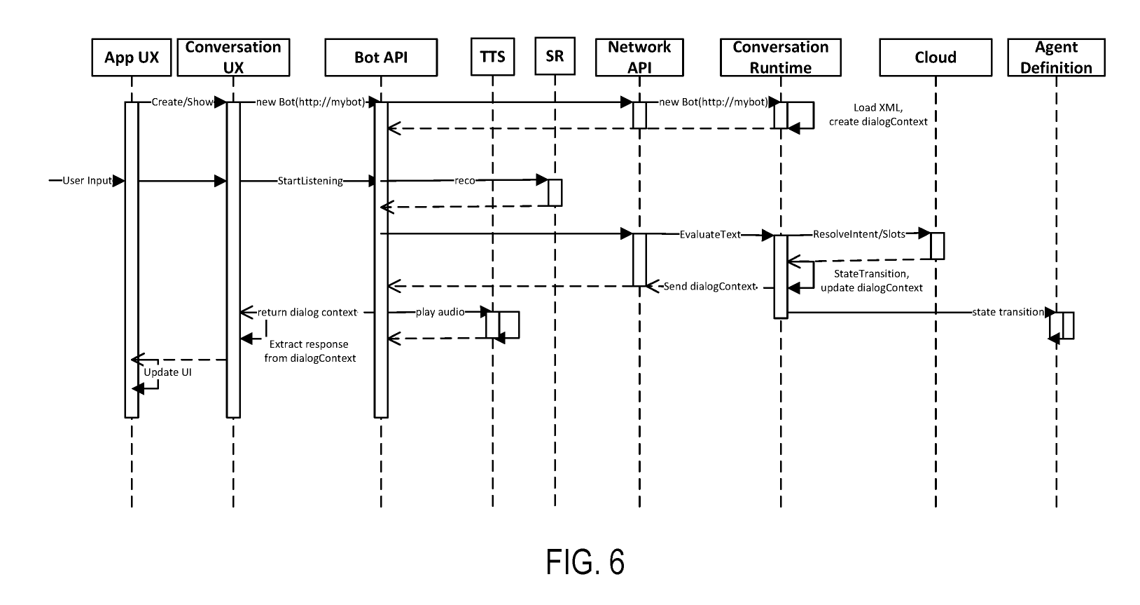

FIG. 6 shows a sequence diagram that illustrates a sequence of calls when a client computing system provides speech-based user input to communicate with a conversation robot program executed by a conversation runtime. When a conversation trigger condition is detected at the client computing system, the conversation runtime executes a conversation dialog by selecting an appropriate agent definition and loading the associated XML files that define the state machine for the conversation dialog. When speech-based user input is received at the client computing system via the conversation application, the client computing system sends the audio data corresponding to the speech-based user input to the speech service computing system to translate the speech to text. The translated text is then sent to the cloud computing system to be evaluated by the conversation runtime based on the policies of the agent definition. The conversation runtime transitions between states of the state machine based on the received text to update the conversation dialog. The conversation robot program may send an appropriate text-based response based on the updated state of the conversation dialog to client computing system. The text-based response is sent to the speech service computing system to translate the text to speech and the translated speech is presented to the user via the conversation application user interface. This sequence (and/or other similar sequences) may be carried out each time speech-based user input is received during execution of the conversation dialog.

In some implementations, the methods and processes described herein may be tied to a computing system comprising one or more computing devices. In particular, such methods and processes may be implemented as a computer-application program or service, an application-programming interface (API), a library, and/or other computer-program product.

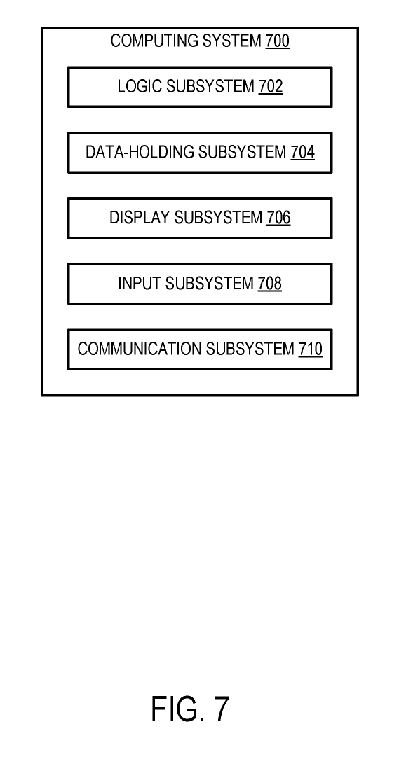

FIG. 7 schematically shows a non-limiting implementation of a computing system 700 that can enact one or more of the methods and processes described above. Computing system 700 is shown in simplified form. Computing system 700 may take the form of one or more personal computers, server computers, tablet computers, home-entertainment computers, network computing devices, gaming devices, mobile computing devices, mobile communication devices (e.g., smart phone), and/or other computing devices. For example, computing system 700 may represent bot cloud service computing system 104, any of the plurality of client devices 106, developer computing system 115, language understanding service computing system 118, and/or speech service computing system 122 of FIG. 1.

Computing system 700 includes a logic subsystem 702 and a data-holding subsystem 704. Computing system 700 may optionally include a display subsystem 706 input subsystem 708, communication subsystem 710, and/or other components not shown in FIG. 7.

Logic subsystem 702 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Data-holding subsystem 704 includes one or more physical devices configured to hold instructions executable by the logic machine to implement the methods and processes described herein. When such methods and processes are implemented, the state of data-holding subsystem 704 may be transformed—e.g., to hold different data.

Data-holding subsystem 704 may include removable and/or built-in devices. Data-holding subsystem 704 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Data-holding subsystem 704 may include volatile, nonvolatile, dynamic, static, read/write, read-only, random-access, sequential-access, location-addressable, file-addressable, and/or content-addressable devices.

It will be appreciated that data-holding subsystem 704 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 702 and data-holding subsystem 704 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 700 implemented to perform a particular function. In some cases, a module, program, or engine may be instantiated via logic subsystem 702 executing instructions held by data-holding subsystem 704. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 706 may be used to present a visual representation of data held by data-holding subsystem 704. This visual representation may take the form of a graphical user interface (GUI). As the herein described methods and processes change the data held by the storage machine, and thus transform the state of the storage machine, the state of display subsystem 706 may likewise be transformed to visually represent changes in the underlying data. Display subsystem 706 may include one or more display devices utilizing virtually any type of technology. Such display devices may be combined with logic subsystem 702 and/or data-holding subsystem 704 in a shared enclosure, or such display devices may be peripheral display devices.

When included, input subsystem 708 may comprise or interface with one or more user-input devices such as a keyboard, mouse, touch screen, or game controller. In some implementations, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 710 may be configured to communicatively couple computing system 700 with one or more other computing devices. Communication subsystem 710 may include wired and/or wireless communication devices compatible with one or more different communication protocols. As non-limiting examples, the communication subsystem may be configured for communication via a wireless telephone network, or a wired or wireless local- or wide-area network. In some implementations, the communication subsystem may allow computing system 700 to send and/or receive messages to and/or from other devices via a network such as the Internet.

In another example, a computing system comprises a logic subsystem, and a data-holding subsystem comprising computer-readable instructions executable by the logic subsystem to execute a conversation runtime configured to receive one or more agent definitions, each agent definition defining a flow of a modeled conversation executable by a conversation robot program, each agent definition defining a state machine including a plurality of states, detect a conversation trigger condition, select an agent definition from the one or more agent definitions for a conversation based on the conversation trigger condition, and execute a conversation dialog with a client computing system using the agent definition selected for the conversation and automatically transition the state machine between different states of the plurality of states during execution of the conversation dialog. In this example and/or other examples, the flow defined by the agent definition may be a directed, structured flow of the modeled conversation. In this example and/or other examples, the conversation runtime may be configured to receive developer-customized execution code, and during execution of the conversation dialog, transition the state machine between states based on customized policies defined by the developer-customized execution code in place of default policies defined by the agent definition. In this example and/or other examples, the conversation runtime may be configured to, during execution of the conversation dialog, receive user input from the client computing system, send the user input to a language-understanding service computing system configured to translate the received user input into one or more values, receive the one or more translated values from the language-understanding service computing system, and transition the state machine between the plurality of states based on the one or more translated values. In this example and/or other examples, the user input may include audio data representing human speech, the language-understanding service computing system may be configured to translate the audio data into text, and the conversation runtime may be configured to transition the state machine based on the text received from the language-understanding service computing system. In this example and/or other examples, the conversation runtime may be configured to generate a response based on transitioning the state machine to a different state, and send the response to the client computing system for presentation by the client computing system. In this example and/or other examples, the response may be a visual response including one or more of text and an image that is sent to the client computing system. In this example and/or other examples, the response may be a speech-based audio response, the conversation runtime may be configured to send text corresponding to the speech-based audio response to a speech service computing system via the client computing system, the speech service computing system may be configured to translate the text to audio data corresponding to the speech-based audio response and send the audio data to the client computing system for presentation of the speech-based response by the client computing system. In this example and/or other examples, the conversation runtime may be configured to receive a plurality of different agent definitions each associated with a different conversation, select the agent definition from the plurality of agent definitions based on the conversation trigger condition, detect a nested conversation trigger condition during execution of the conversation dialog, select a different agent definition from the plurality of agent definitions for a nested conversation based on the nested conversation trigger condition, and execute a nested conversation dialog with the client computing system using the selected different agent definition. In this example and/or other examples, the conversation trigger condition may include user input received by the computing system from the client computing system that triggers execution of the conversation. In this example and/or other examples, the conversation trigger condition may include a sensor signal received by the computing system from the client computing system that triggers execution of the conversation.

In another example, a method for executing a conversation dialog with a client computing system using a conversation runtime comprises receiving one or more agent definitions, each agent definition defining a flow of a modeled conversation executable by a conversation robot program, each agent definition defining a state machine including a plurality of states, detecting a conversation trigger condition, selecting an agent definition from the one or more agent definitions for a conversation based on the conversation trigger condition, and executing, via the conversation runtime, a conversation dialog with the client computing system using the agent definition selected for the conversation and automatically transitioning, via the conversation runtime, the state machine between different states of the plurality of states during execution of the conversation dialog. In this example and/or other examples, the method may further comprise receiving a plurality of different agent definitions each associated with a different conversation, and selecting the agent definition from the plurality of agent definitions based on the conversation trigger condition. In this example and/or other examples, the method may further comprise detecting a nested conversation trigger condition during execution of the conversation dialog, selecting a different agent definition from the plurality of agent definitions for a nested conversation based on the nested conversation trigger condition, and executing a nested conversation dialog with the client computing system using the selected different agent definition. In this example and/or other examples, the method may further comprise receiving developer-customized execution code, and during execution of the conversation dialog, transitioning, via the conversation runtime, the state machine between states based on customized policies defined by the developer-customized execution code in place of default policies defined by the agent definition. In this example and/or other examples, the method may further comprise receiving user input from the client computing system, sending the user input to a language-understanding service computing system configured to translate the received user input into one or more values, receiving the one or more translated values from the language-understanding service computing system, and transitioning the state machine between the plurality of states based on the one or more translated values. In this example and/or other examples, the user input may include audio data representing human speech, the language-understanding service computing system conversation runtime may be configured to translate the audio data into text, and the conversation runtime may be configured to transition the state machine based on the text received from the language-understanding service computing system.

In another example, a computing system comprises a logic subsystem, and a data-holding subsystem comprising computer-readable instructions executable by the logic subsystem to execute a conversation runtime configured to receive a plurality of agent definitions, each agent definition of the plurality of agent definitions defining a state machine defining a flow of a modeled conversation executable by a conversation robot program, each state machine including a plurality of states, detect a conversation trigger condition, select an agent definition from the plurality of agent definitions for a conversation based on the conversation trigger condition, and execute a conversation dialog with a client computing system using the agent definition selected for the conversation and automatically transitioning the state machine between different states of the plurality of states during execution of the conversation dialog. In this example and/or other examples, the conversation trigger condition may include user input received by the computing system from the client computing system that triggers execution of the conversation. In this example and/or other examples, the conversation trigger condition may include a sensor signal received by the computing system from the client computing system that triggers execution of the conversation.

It will be understood that the configurations and/or approaches described herein are exemplary in nature, and that these specific implementations or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing system, comprising:
a logic subsystem; and
a data-holding subsystem comprising computer-readable instructions executable by the logic subsystem to execute a conversation runtime configured to
receive one or more agent definitions, each agent definition defining a flow of a modeled conversation executable by a conversation robot program, each agent definition defining a state machine including a plurality of states;
detect a conversation trigger condition;
select an agent definition from the one or more agent definitions for a conversation based on the conversation trigger condition; and
execute a conversation dialog with a client computing system using the agent definition selected for the conversation and automatically transition the state machine between different states of the plurality of states during execution of the conversation dialog.

2. The computing system of claim 1, wherein the flow defined by the agent definition is a directed, structured flow of the modeled conversation.

3. The computing system of claim 1, wherein the conversation runtime is configured to receive developer-customized execution code, and during execution of the conversation dialog, transition the state machine between states based on customized policies defined by the developer-customized execution code in place of default policies defined by the agent definition.

4. The computing system of claim 1, wherein the conversation runtime is configured to, during execution of the conversation dialog
receive user input from the client computing system;
send the user input to a language-understanding service computing system configured to translate the received user input into one or more values;
receive the one or more values from the language-understanding service computing system; and
transition the state machine between the plurality of states based on the one or more translated values.

5. The computing system of claim 4, wherein if the user input includes audio data representing human speech, then the language-understanding service computing system is configured to translate the audio data into text and determine the one or more values based upon the text, wherein if the user input includes text, then the language-understanding service computing system is configured to determine the one or more values based upon the text.

6. The computing system of claim 5, wherein the conversation runtime is configured to:
generate a response based on transiting the state machine to a different state; and
send the response to the client computing system for presentation by the client computing system.

7. The computing system of claim 6, wherein the response is a visual response including one or more of text, a video, and an image that is sent to the client computing system.

8. The computing system of claim 6, wherein the response is a speech-based audio response, wherein the conversation runtime is configured to send text corresponding to the speech-based audio response to a speech service computing system, wherein the speech service computing system is configured to translate the text to audio data corresponding to the speech-based audio response, and wherein the audio data is sent to the client computing system for presentation of the speech-based response by the client computing system.

9. The computing system of claim 1, wherein the conversation runtime is configured to
receive a plurality of different agent definitions each associated with a different conversation;
select the agent definition from the plurality of agent definitions based on the conversation trigger condition;
detect a nested conversation trigger condition during execution of the conversation dialog;
select a different agent definition from the plurality of agent definitions for a nested conversation based on the nested conversation trigger condition; and
execute a nested conversation dialog with the client computing system using the selected different agent definition.

10. The computing system of claim 1, wherein the conversation trigger condition includes user input received by the computing system from the client computing system that triggers execution of the conversation.

11. The computing system of claim 1, wherein the conversation trigger condition includes a sensor signal received by the computing system from the client computing system that triggers execution of the conversation.

12. A method for executing a conversation dialog with a client computing system using a conversation runtime, the method comprising:
receiving one or more agent definitions, each agent definition defining a flow of a modeled conversation executable by a conversation robot program, each agent definition defining a state machine including a plurality of states;
detecting a conversation trigger condition;
selecting an agent definition from the one or more agent definitions for a conversation based on the conversation trigger condition; and
executing, via the conversation runtime, a conversation dialog with the client computing system using the agent definition selected for the conversation and automatically transitioning, via the conversation runtime, the state machine between different states of the plurality of states during execution of the conversation dialog.

13. The method of claim 12, further comprising:
receiving a plurality of different agent definitions each associated with a different conversation; and
selecting the agent definition from the plurality of agent definitions based on the conversation trigger condition.

14. The method of claim 13, further comprising
detecting a nested conversation trigger condition during execution of the conversation dialog;
selecting a different agent definition from the plurality of agent definitions for a nested conversation based on the nested conversation trigger condition; and
executing a nested conversation dialog with the client computing system using the selected different agent definition.

15. The method of claim 12, further comprising:
receiving developer-customized execution code;
and during execution of the conversation dialog, transitioning, via the conversation runtime, the state machine between states based on customized policies defined by the developer-customized execution code in place of default policies defined by the agent definition.

16. The method of claim 12, further comprising:
receiving user input from the client computing system;
sending the user input to a language-understanding service computing system configured to translate the received user input into one or more values;
receiving the one or more translated values from the language-understanding service computing system; and
transitioning the state machine between the plurality of states based on the one or more translated values.

17. The method of claim 16, wherein the user input includes audio data representing human speech, wherein the language-understanding service computing system conversation runtime is configured to translate the audio data into text, and wherein the conversation runtime is configured to transition the state machine based on the text received from the language-understanding service computing system.

18. A computing system, comprising:
a logic subsystem; and
a data-holding subsystem comprising computer-readable instructions executable by the logic subsystem to execute a conversation runtime configured to
receive a plurality of agent definitions, each agent definition of the plurality of agent definitions defining a state machine defining a flow of a modeled conversation executable by a conversation robot program, each state machine including a plurality of states;
detect a conversation trigger condition;
select an agent definition from the plurality of agent definitions for a conversation based on the conversation trigger condition; and
execute a conversation dialog with a client computing system using the agent definition selected for the conversation and automatically transitioning the state machine between different states of the plurality of states during execution of the conversation dialog.

19. The computing system of claim 18, wherein the conversation trigger condition includes user input received by the computing system from the client computing system that triggers execution of the conversation.

20. The computing system of claim 18, wherein the conversation trigger condition includes a sensor signal received by the computing system from the client computing system that triggers execution of the conversation.
